(19) United States
(12) Patent Application Publication
(10) Pub. No.: US 2025/0370225 A1
(43) Pub. Date: Dec. 4, 2025

(54) OPTICAL IMAGING SYSTEM

(71) Applicant: Samsung Electro-Mechanics Co., Ltd., Suwon-si (KR)

(72) Inventors: Ji Su LEE, Suwon-si (KR); Yong Joo JO, Suwon-si (KR)

(73) Assignee: Samsung Electro-Mechanics Co., Ltd., Suwon-si (KR)

(21) Appl. No.: 19/080,162

(22) Filed: Mar. 14, 2025

(30) Foreign Application Priority Data
Jun. 3, 2024 (KR) 10-2024-0072321

(51) Int. Cl. G02B 13/00; G02B 9/62

(52) U.S. Cl. CPC G02B 13/0045; G02B 9/62

(57) ABSTRACT

An optical imaging system includes a first lens having positive refractive power, a second lens having negative refractive power, a third lens having positive refractive power, a fourth lens having negative refractive power, a fifth lens having positive refractive power, and a sixth lens having negative refractive power, disposed in order from an object side, and a cemented lens, wherein the cemented lens includes the first lens and the second lens or the third lens and the fourth lens.

### CROSS-REFERENCE TO RELATED APPLICATIONS

This application claims the benefit under 35 USC 119(a) of Korean Patent Application No. 10-2024-0072321 filed on Jun. 3, 2024, in the Korean Intellectual Property Office, the entire disclosure of which is incorporated herein by reference for all purposes.

### BACKGROUND

### 1. Field

The present disclosure relates to an optical imaging system.

### 2. Description of the Background

Cameras may be mounted on a mobile device.

For example, a high-resolution image sensor may be employed in a camera for a mobile device, and an optical system may also be employed accordingly.

Generally, as a size of an image sensor increases, a total optical length of an optical system increases. However, since it may be an objective for a mobile device to have a slim size, development of an optical system which may address the issue of performance degradation due to slimming and which may implement high resolution may be an objective.

The above information is presented as background information only to assist with an understanding of the present disclosure. No determination has been made, and no assertion is made, as to whether any of the above might be applicable as prior art with regard to the disclosure.

### SUMMARY

The above information is presented as background information only to assist with an understanding of the present disclosure. No determination has been made, and no assertion is made, as to whether any of the above might be applicable as prior art with regard to the disclosure.

In one general aspect, an optical imaging system includes a first lens having positive refractive power, a second lens having negative refractive power, a third lens having positive refractive power, a fourth lens having negative refractive power, a fifth lens having positive refractive power, and a sixth lens having negative refractive power, disposed in order from an object side, and a cemented lens, wherein the cemented lens includes the first lens and the second lens or the third lens and the fourth lens.

The cemented lens may include the first lens and the second lens, and an object-side surface of the second lens may be convex in a paraxial region.

The cemented lens may include the third lens and the fourth lens, and an object-side surface of the fourth lens may be concave in a paraxial region.

The cemented lens may satisfy the following conditional expression: 0≤|fa/Va−fb/Vb|<2, where fa and Va are a focal length and an Abbe number of a lens disposed on an object side among lenses cemented to each other, respectively, and fb and Vb are a focal length and an Abbe number of a lens disposed on an image side among the two lenses cemented to each other, respectively.

An object-side surface of the fifth lens may be concave in a paraxial region.

An image-side surface of the second lens may be concave in a paraxial region.

An image-side surface of the sixth lens may be concave in a paraxial region.

The optical imaging system may satisfy the following conditional expression: 1.0<TTL/f<1.3, where TTL is a distance along an optical axis from an object-side surface of the first lens to an image plane, and f is a total focal length of the optical imaging system.

The first lens to the sixth lens may be formed of plastic material.

In another general aspect, an optical imaging system includes a first lens, a second lens, a third lens having positive refractive power, a fourth lens having negative refractive power and a convex object-side surface, a fifth lens having positive refractive power, and a sixth lens having negative refractive power, disposed in order from an object side, wherein the optical imaging system satisfies the following conditional expression: 0.5<TTL/(2*IMG HT)<0.8, where TTL is a distance along an optical axis from an object-side surface of the first lens to an image plane, and IMG HT is half a diagonal length of the image plane.

The optical imaging system may satisfy the following conditional expression: −5<f4/f<0, where f4 is a focal length of the fourth lens, and f is a total focal length of the optical imaging system.

The optical imaging system may satisfy the following conditional expression: −2<f6/f<0, where f6 is a focal length of the sixth lens, and f is a total focal length of the optical imaging system.

The optical imaging system may satisfy the following conditional expression: 1<f3/f<8, where f3 is a focal length of the third lens, and f is a total focal length of the optical imaging system.

The optical imaging system may further include a cemented lens including the first lens and the second lens, wherein an image-side surface of the third lens may be concave in a paraxial region.

The optical imaging system may further include a cemented lens including the third lens and the fourth lens, wherein an image-side surface of the third lens may be convex in a paraxial region.

An image-side surface of the second lens may be concave in a paraxial region, and an image-side surface of the fifth lens may be convex in a paraxial region.

Other features and aspects will be apparent from the following detailed description, the drawings, and the claims.

### BRIEF DESCRIPTION OF DRAWINGS

FIG. 1A is a configuration diagram illustrating an optical imaging system according to a first embodiment of the present disclosure.

FIG. 1B is a graph indicating aberration properties of the optical imaging system illustrated in FIG. 1A.

FIG. 2A is a configuration diagram illustrating an optical imaging system according to a second embodiment of the present disclosure.

FIG. 2B is a graph indicating aberration properties of the optical imaging system illustrated in FIG. 2A.

FIG. 3A is a configuration diagram illustrating an optical imaging system according to a third embodiment of the present disclosure.

FIG. 3B is a graph indicating aberration properties of the optical imaging system illustrated in FIG. 3A.

FIG. 4A is a configuration diagram illustrating an optical imaging system according to a fourth embodiment of the present disclosure.

FIG. 4B is a graph indicating aberration properties of the optical imaging system illustrated in FIG. 4A.

FIG. 5A is a configuration diagram illustrating an optical imaging system according to a fifth embodiment of the present disclosure.

FIG. 5B is a graph indicating aberration properties of the optical imaging system illustrated in FIG. 5A.

FIG. 6A is a configuration diagram illustrating an optical imaging system according to a sixth embodiment of the present disclosure.

FIG. 6B is a graph indicating aberration properties of the optical imaging system illustrated in FIG. 6A.

FIG. 7A is a configuration diagram illustrating an optical imaging system according to a seventh embodiment of the present disclosure.

FIG. 7B is a graph indicating aberration properties of the optical imaging system illustrated in FIG. 7A.

FIG. 8A is a configuration diagram illustrating an optical imaging system according to an eighth embodiment of the present disclosure.

FIG. 8B is a graph indicating aberration properties of the optical imaging system illustrated in FIG. 8A.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure may provide an optical imaging system having a slim size which may obtain a high-resolution image.

In embodiments, a first lens may indicate a lens closest to the object side, and a sixth lens may indicate a lens closest to an image sensor side (or image side).

Also, in each lens, the first surface may indicate the surface closest to the object side (or object-side surface), and the second surface may indicate the surface closest to the image sensor side (or image-side surface).

In the description related to the shape of a lens of the embodiments, a convex surface may indicate that a paraxial region portion of a surface may be convex, and a concave surface may indicate that a paraxial region portion of the surface may be concave. A paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid. Accordingly, even when one surface of the lens is described as having a convex shape, an edge portion of the lens may be concave. Similarly, although one surface of a lens is described as having a concave shape, an edge portion of the lens may be convex.

In the embodiments, length-related parameters, including a unit of a radius of curvature, thickness, distance, and focal length of a lens may be millimeter (mm), and a unit of the field of view (FOV) may be degree) (°.

The optical imaging system according to embodiments may include six lenses. For example, the optical imaging system may include a first lens, a second lens, a third lens, a fourth lens, a fifth lens, and a sixth lens disposed in order from an object side.

However, the optical imaging system according to embodiments may not include only six lenses.

For example, the optical imaging system may further include an image sensor configured to convert an image of an incident object into an electrical signal.

Also, for example, the optical imaging system may further include an infrared blocking filter (hereinafter, “filter”) configured to block infrared light among light incident to the image sensor. For example, the filter may be disposed between the sixth lens and the image sensor.

Also, for example, the optical imaging system may further include a stop configured to adjust the amount of light.

The optical imaging system according to embodiments may include a cemented lens. For example, two lenses disposed adjacently to each other among the first to sixth lenses may be provided as a cemented lens.

Specifically, the cemented lens may be provided in a form in which an image-side surface of a lens disposed close to an object side and an object-side surface of a lens disposed close to an image side among the two lenses disposed adjacently to each other are bonded to each other. In this case, the two surfaces bonded to each other may be the same aspherical surface or the same spherical surface.

According to embodiments, the two lenses disposed adjacently to each other, provided as the cemented lens, may be bonded through a bond. For example, a bond satisfying predetermined conditions of a refractive index and Abbe number may be used for lens bonding, and the bond may be applied between the two lenses disposed adjacently to each other with a thickness of approximately 1 to 50 μm (micrometers).

According to embodiments, refractive powers of the two lenses disposed adjacently to each other, provided as the cemented lens, may be opposite to each other. For example, among the two lenses provided as a cemented lens, the lens disposed closer to an object side may have positive or negative refractive power, and the lens disposed closer to an image side may have negative or positive refractive power, respectively.

The optical imaging system according to embodiments may include a lens formed of a plastic material. For example, the entirety of the first to sixth lenses included in the optical imaging system may be formed of a plastic material.

Also, each lens may have different optical properties from the adjacently disposed lenses. For example, the adjacently disposed lenses may have different refractive indices and Abbe numbers.

The optical imaging system according to embodiments may include an aspherical surface lens. That is, at least one surface of at least one of the first to sixth lenses included in the optical imaging system may be an aspherical surface. For example, at least one surface of each of the first to sixth lenses may be an aspherical surface.

Here, the aspherical surface may be represented as [Equation 1] below.

$$[ Equation 1 ]$$

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30}$$

In equation 1, c is the radius of curvature of the lens (reciprocal of a radius of curvature), K is a conic constant, Y is the distance from any point on the aspherical surface of the lens to the optical axis, A-H, J, and L-P are aspherical constants, and Z (or SAG) may be the distance in the optical axis direction from any point on the aspherical surface of the lens to an apex of the aspherical surface.

An optical imaging system according to embodiments may satisfy conditional expressions as below.

$$0 \leq \vert fa / Va - fb / Vb \vert < 2 \qquad [ Conditional expression 1 ]$$

$$10 < Vc < 80 \qquad [ Conditional expression 2 ]$$

$$Nb < Nc < Na \qquad [ Conditional expression 3 ]$$

In [Conditional expression 1], fa, Va, and Na may be the focal length, Abbe number, and refractive index, respectively, of a lens disposed on an object side among two lenses bonded to each other, and fb, Vb, and Nb may be the focal length, Abbe number, and refractive index, respectively, of a lens disposed on an image side among two lenses bonded to each other. Also, in [Conditional expression 2] and [Conditional expression 3], Vc may be the Abbe number of the bond, and Nc may be the refractive index of the bond.

[Conditional expression 1] to [Conditional expression 3] may be related to optical properties conditions of the bond used in the cemented lens and lens bonding for chromatic aberration correction. Particularly, [Conditional expression 1] may be a Conditional expression related to dechromatization of the optical imaging system, and when the conditional expression range is satisfied, chromatic aberration may be less likely to occur.

Also, the optical imaging system according to embodiments may satisfy at least one of the conditional expressions below.

$$0.5 < f 1 / f < 2 \qquad [ Conditional expression 4 ]$$

$$- 3 < f 2 / f < - 1 \qquad [ Conditional expression 5 ]$$

$$1 < f 3 / f < 8 \qquad [ Conditional expression 6 ]$$

$$- 5 < f 4 / f < - 1 \qquad [ Conditional expression 7 ]$$

$$0 < f 5 / f < 2 \qquad [ Conditional expression 8 ]$$

$$- 2 < f 6 / f < 0 \qquad [ Conditional expression 9 ]$$

$$1. < TTL / f < 1.3 \qquad [ Conditional expression 10 ]$$

$$0 < BFL / f < 0.3 \qquad [ Conditional expression 11 ]$$

$$0.5 < TTL / ( 2 * IMG HT ) < 0.8 \qquad [ Conditional expression 12 ]$$

$$1 < f / EPD < 3 \qquad [ Conditional expression 13 ]$$

In [Conditional expression 4] to [Conditional expression 13], f is the total focal length of the optical imaging system, f1 is the focal length of the first lens, f2 is the focal length of the second lens, f3 is the focal length of the third lens, f4 is the focal length of the fourth lens, f5 is the focal length of the fifth lens, f6 is the focal length of the sixth lens, TTL is the distance on the optical axis from an object-side surface of the first lens to an image plane, BFL is the distance on the optical axis from an image-side surface of the sixth lens to the image plane, IMG HT is half the diagonal length of the image plane (that is, 2*IMG HT is the diagonal length of the image plane), and EPD is the diameter of the entrance pupil.

[Conditional expression 4] to [Conditional expression 9] may be a ratio of the focal length of each lens to the total focal length of the optical imaging system, and may be related to appropriate refractive power of each lens for aberration correction. Also, [Conditional expression 10] to [Conditional expression 12] are related to miniaturization of the optical imaging system, and [Conditional expression 13] may be related to the brightness performance of the optical imaging system.

### First Embodiment

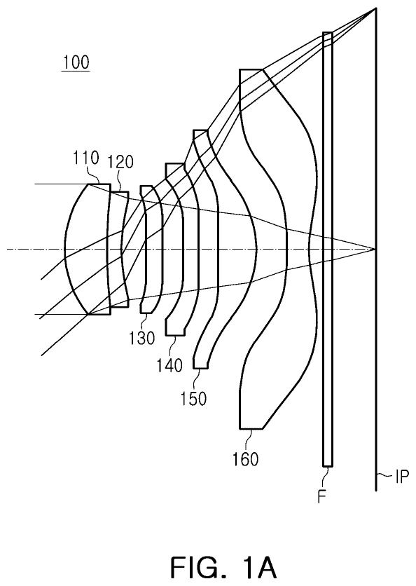

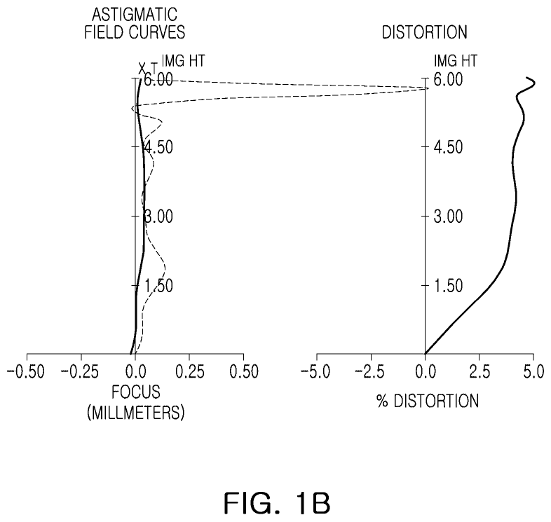

FIG. 1A is a configuration diagram illustrating an optical imaging system according to a first embodiment. FIG. 1B is a graph indicating aberration properties of the optical imaging system illustrated in FIG. 1A.

The optical imaging system 100 according to the first embodiment may include a first lens 110, a second lens 120, a third lens 130, a fourth lens 140, a fifth lens 150, and a sixth lens 160. A stop may be disposed between the second lens 120 and the third lens 130.

Also, the optical imaging system 100 may include a filter F and an imaging plane IP disposed on an image side of the sixth lens 160. The imaging plane IP may be a portion of an image sensor, in which light is received.

The total focal length of the optical imaging system 100 according to the first embodiment may be 6.13 mm, the IMG HT may be 6.00 mm, and the FOV may be 85.90 degrees) (°.

The characteristics of each lens of the optical imaging system 100 according to the first embodiment may be as in Table 1 below.

TABLE 1

| Surface | | Radius of | Thickness/ | Refractive | Abbe | Focal |
|---|---|---|---|---|---|---|
| No. | Note | curvature | Distance | index | number | length |
| S1 | First | 2.529 | 1.036 | 1.558 | 59.13 | 5.68 |
| | lens | | | | | |
| S2 | | 10.466 | 0.000 | | | |
| S3 | Second | 10.466 | 0.341 | 1.690 | 21.97 | −13.73 |
| | lens | | | | | |
| S4 | | 4.933 | 0.581 | | | |
| S5 | Third | 16.885 | 0.429 | 1.544 | 55.99 | 39.59 |
| | lens | | | | | |
| S6 | | 76.304 | 0.465 | | | |
| S7 | Fourth | 12.444 | 0.366 | 1.661 | 20.38 | −21.82 |
| | lens | | | | | |
| S8 | | 6.635 | 0.461 | | | |
| S9 | Fifth | −28.058 | 0.915 | 1.544 | 55.99 | 4.22 |
| | lens | | | | | |
| S10 | | −2.153 | 0.763 | | | |
| S11 | Sixth | −14.481 | 0.496 | 1.535 | 55.74 | −4.15 |
| | lens | | | | | |
| S12 | | 2.669 | 0.329 | | | |
| S13 | Filter | Infinity | 0.246 | 1.517 | 64.20 | |
| S14 | | Infinity | 1.032 | | | |
| S15 | Imaging | Infinity | | | | |
| | plane | | | | | |

According to the first embodiment, the first lens 110 may have positive refractive power, the first surface (an object-side surface) of the first lens 110 may be convex in a paraxial region, and the second surface (an image-side surface) of the first lens 110 may be concave in a paraxial region.

The second lens 120 may have negative refractive power, the first surface (an object-side surface) of the second lens 120 may be convex in a paraxial region, and the second surface (an image-side surface) of the second lens 120 may be concave in a paraxial region.

The third lens 130 may have positive refractive power, and the first surface (an object-side surface) of the third lens 130 may be convex in a paraxial region, and the second surface (an image-side surface) of the third lens 130 may be concave in a paraxial region.

The fourth lens 140 may have negative refractive power, and the first surface (an object-side surface) of the fourth lens 140 may be convex in a paraxial region, and the second surface (an image-side surface) of the fourth lens 140 may be concave in a paraxial region.

The fifth lens 150 may have positive refractive power, and the first surface (an object-side surface) of the fifth lens 150 may be concave in a paraxial region, and the second surface (an image-side surface) of the fifth lens 150 may be convex in a paraxial region.

The sixth lens 160 may have negative refractive power, and both the first surface (an object-side surface) of the sixth lens 160 and the second surface (an image-side surface) of the sixth lens 160 may be concave in paraxial regions.

According to the first embodiment, the first lens 110 and the second lens 120 may be configured as a cemented lens.

For example, the second surface (an image-side surface) of the first lens 110 and the first surface (an object-side surface) of the second lens 120 bonded to the second surface (an image-side surface) of the first lens 110 may be spherical surfaces.

According to the first embodiment, at least one surface of each of the first to sixth lenses 110-160 may be an aspherical surface.

Aspherical constants of each lens of the optical imaging system 100 according to the first embodiment may be as in Table 2 below.

TABLE 2

| | S1 | S2 | S3 | S4 | S5 | S6 |
|---|---|---|---|---|---|---|
| K | 0.026 | 0.000 | 0.000 | −44.813 | −61.018 | −6.566 |
| A | −5.330E−03 | 0.00E+00 | 0.00E+00 | 3.738E−02 | −8.885E−02 | −8.900E−02 |
| B | 2.257E−02 | 0.00E+00 | 0.00E+00 | 8.701E−02 | 5.905E−01 | 4.046E−01 |
| C | −4.225E−02 | 0.00E+00 | 0.00E+00 | −6.245E−01 | −2.902E+00 | −1.797E+00 |
| D | 2.355E−02 | 0.00E+00 | 0.00E+00 | 2.121E+00 | 9.288E+00 | 5.451E+00 |
| E | 6.709E−02 | 0.00E+00 | 0.00E+00 | −4.467E+00 | −2.056E+01 | −1.157E+01 |
| F | −1.718E−01 | 0.00E+00 | 0.00E+00 | 5.838E+00 | 3.251E+01 | 1.752E+01 |
| G | 1.963E−01 | 0.00E+00 | 0.00E+00 | −3.812E+00 | −3.756E+01 | −1.917E+01 |
| H | −1.362E−01 | 0.00E+00 | 0.00E+00 | −1.237E+00 | 3.202E+01 | 1.528E+01 |
| J | 6.172E−02 | 0.00E+00 | 0.00E+00 | 5.445E+00 | −2.013E+01 | −8.855E+00 |
| L | −1.861E−02 | 0.00E+00 | 0.00E+00 | −5.822E+00 | 9.212E+00 | 3.685E+00 |
| M | 3.681E−06 | 0.00E+00 | 0.00E+00 | 3.491E+00 | −2.988E+00 | −1.072E+00 |
| N | −4.548E−04 | 0.00E+00 | 0.00E+00 | −1.257E+00 | 6.512E−01 | 2.065E−01 |
| O | 3.141E−05 | 0.00E+00 | 0.00E+00 | 2.542E−01 | −8.562E−02 | −2.368E−02 |
| P | −9.052E−07 | 0.00E+00 | 0.00E+00 | −2.227E−02 | 5.139E−03 | 1.221E−03 |
| | S7 | S8 | S9 | S10 | S11 | S12 |
| K | −31.915 | 5.109 | 41.128 | −6.151 | 10.490 | −7.075 |
| A | −6.283E−02 | −5.695E−02 | 2.752E−02 | −9.141E−03 | −6.346E−02 | −3.429E−02 |
| B | −1.027E−01 | −6.729E−02 | −1.058E−01 | −6.259E−02 | 4.563E−02 | 1.159E−02 |
| C | 4.323E−01 | 1.819E−01 | 1.822E−01 | 1.111E−01 | −4.728E−02 | −6.562E−03 |
| D | −1.009E+00 | −2.752E−01 | −2.196E−01 | −1.117E−01 | 2.973E−02 | 2.923E−03 |
| E | 1.562E+00 | 2.797E−01 | 1.788E−01 | 7.152E−02 | −1.124E−02 | −8.426E−04 |
| F | −1.663E+00 | −1.939E−01 | −9.966E−02 | −3.073E−02 | 2.771E−03 | 1.627E−04 |
| G | 1.241E+00 | 9.114E−02 | 3.900E−02 | 9.224E−03 | −4.688E−04 | −2.191E−05 |
| H | −6.549E−01 | −2.801E−02 | −1.089E−02 | −1.981E−03 | 5.594E−05 | 2.103E−06 |
| J | 2.435E−01 | 4.971E−03 | 2.178E−03 | 3.070E−04 | −4.761E−06 | −1.448E−07 |
| L | −6.270E−02 | −2.139E−04 | −3.092E−04 | −3.410E−05 | 2.878E−07 | 7.091E−09 |
| M | 1.078E−02 | −1.140E−04 | 3.038E−05 | 2.651E−06 | −1.208E−08 | −2.413E−10 |
| N | −1.156E−03 | 2.758E−05 | −1.963E−06 | −1.369E−07 | 3.352E−10 | 5.428E−12 |
| O | 6.684E−05 | −2.688E−06 | 7.494E−08 | 4.223E−09 | −5.529E−12 | −7.263E−14 |
| P | −1.435E−06 | 1.020E−07 | −1.281E−09 | −5.882E−11 | 4.109E−14 | 4.388E−16 |

### Second Embodiment

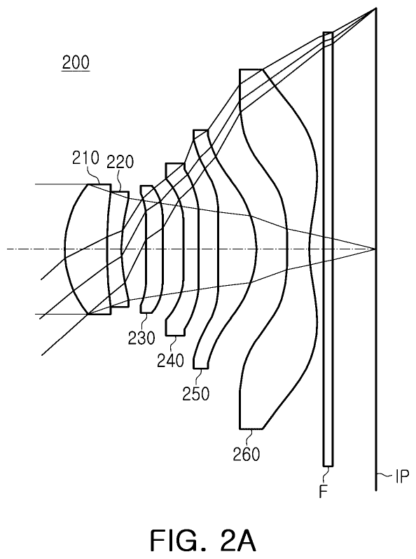

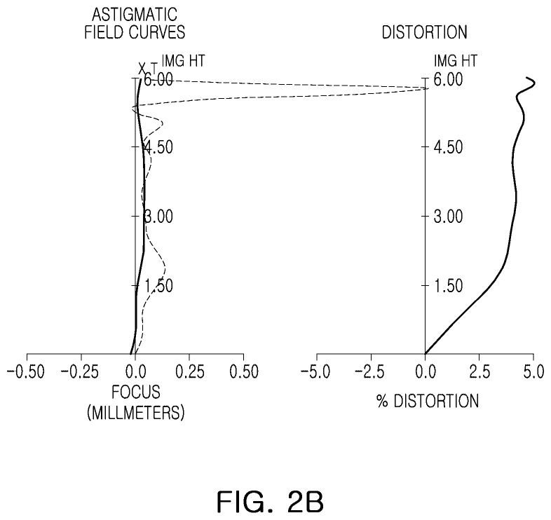

FIG. 2A is a configuration diagram illustrating an optical imaging system according to a second embodiment. FIG. 2B is a graph indicating aberration properties of the optical imaging system illustrated in FIG. 2A.

An optical imaging system 200 according to a second embodiment may include a first lens 210, a second lens 220, a third lens 230, a fourth lens 240, a fifth lens 250, and a sixth lens 260. A stop may be disposed between the second lens 220 and the third lens 230.

Also, the optical imaging system 200 may include a filter F and an imaging plane IP disposed on an image side of the sixth lens 260. The imaging plane IP may be a portion of an image sensor, in which light is received.

The total focal length of the optical imaging system 200 according to the second embodiment may be 6.11 mm, the IMG HT may be 6.00 mm, and the FOV may be 86.80 degrees (°).

The characteristics of each lens of the optical imaging system 200 according to the second embodiment may be as in Table 3 below.

TABLE 3

| Surface | | Radius of | Thickness/ | Refractive | Abbe | Focal |
|---|---|---|---|---|---|---|
| No. | Note | curvature | Distance | index | number | length |
| S1 | First | 2.527 | 1.045 | 1.559 | 58.98 | 5.66 |
| | lens | | | | | |
| S2 | | 10.559 | 0.000 | | | |
| S3 | Second | 10.559 | 0.344 | 1.690 | 22.04 | −13.58 |
| | lens | | | | | |
| S4 | | 4.926 | 0.584 | | | |
| S5 | Third | 17.010 | 0.434 | 1.544 | 55.99 | 40.04 |
| | lens | | | | | |
| S6 | | 75.803 | 0.465 | | | |
| S7 | Fourth | 12.380 | 0.367 | 1.661 | 20.38 | −21.91 |
| | lens | | | | | |
| S8 | | 6.629 | 0.459 | | | |
| S9 | Fifth | −28.402 | 0.919 | 1.544 | 55.99 | 4.22 |
| | lens | | | | | |
| S10 | | −2.156 | 0.763 | | | |
| S11 | Sixth | −14.481 | 0.490 | 1.535 | 55.74 | −4.20 |
| | lens | | | | | |
| S12 | | 2.705 | 0.329 | | | |
| S13 | Filter | Infinity | 0.246 | 1.517 | 64.20 | |
| S14 | | Infinity | 1.014 | | | |
| S15 | Imaging | Infinity | | | | |
| | plane | | | | | |

According to the second embodiment, the first lens 210 may have positive refractive power, the first surface (an object-side surface) of the first lens 210 may be convex in a paraxial region, and the second surface (an image-side surface) of the first lens 210 may be concave in a paraxial region.

The second lens 220 may have negative refractive power, the first surface (an object-side surface) of the second lens 220 may be convex in a paraxial region, and the second surface (an image-side surface) of the second lens 220 may be concave in a paraxial region.

The third lens 230 may have positive refractive power, the first surface (an object-side surface) of the third lens 230 may be convex in a paraxial region, and the second surface (an image-side surface) of the third lens 230 may be concave in a paraxial region.

The fourth lens 240 may have negative refractive power, the first surface (an object-side surface) of the fourth lens 240 may be convex in a paraxial region, and the second surface (an image-side surface) of the fourth lens 240 may be concave in a paraxial region.

The fifth lens 250 may have positive refractive power, the first surface (an object-side surface) of the fifth lens 250 may be concave in a paraxial region, and the second surface (an image-side surface) of the fifth lens 250 may be convex in a paraxial region.

The sixth lens 260 may have negative refractive power, and both the first surface (an object-side surface) of the sixth lens 260 and the second surface (an image-side surface) of the sixth lens 260 may be concave in a paraxial region.

According to the second embodiment, the first lens 210 and the second lens 220 may be configured as a cemented lens.

For example, the second surface (an image-side surface) of the first lens 210 and the first surface (an object-side surface) of the second lens 220 bonded to the second surface (an image-side surface) of the first lens 210 may be aspherical surfaces.

According to the second embodiment, at least one surface of each of the first to sixth lenses 210-260 may be an aspherical surface.

Aspherical constants of each lens of the optical imaging system 200 according to the second embodiment may be as in Table 4 below.

TABLE 4

| | S1 | S2 | S3 | S4 | S5 | S6 |
|---|---|---|---|---|---|---|
| K | 0.028 | 1.311 | 1.311 | −44.639 | −62.541 | 5.034 |
| A | −3.514E−03 | −7.444E−03 | −7.444E−03 | 4.016E−02 | −8.931E−02 | −8.587E−02 |
| B | 5.729E−03 | 2.329E−01 | 2.329E−01 | 1.107E−02 | 6.163E−01 | 3.738E−01 |
| C | 3.729E−02 | −2.118E+00 | −2.118E+00 | 1.810E−01 | −3.159+00 | −1.617E+00 |
| D | −1.912E−01 | 9.837E+00 | 9.837E+00 | −2.586E+00 | 1.051E+01 | 4.776E+00 |
| E | 4.296E−01 | −2.782E+01 | −2.782E+01 | 1.276E+01 | −2.404E+01 | −9.919E+00 |
| F | −5.779E−01 | 5.200E+01 | 5.200E+01 | −3.641E+01 | 3.903E+01 | 1.480E+01 |
| G | 5.096E−01 | −6.720E+01 | −6.720E+01 | 6.819E+01 | −4.592E+01 | −1.611E+01 |
| H | −3.161E−01 | 6.151E+01 | 6.151E+01 | −8.822E+01 | 3.956E+01 | 1.285E+01 |
| J | 1.270E−01 | −4.022E+01 | −4.022E+01 | 8.037E+01 | −2.495E+01 | −7.485E+00 |
| L | −3.627E−02 | 1.868E+01 | 1.868E+01 | −5.149E+01 | 1.138E+01 | 3.142E+00 |
| M | 6.968E−03 | −6.028E+00 | −6.028E+00 | 2.272E+01 | −3.661E+00 | −9.233E−01 |
| N | −8.553E−04 | 1.285E+00 | 1.285E+00 | −6.573E+00 | 7.871E−01 | 1.800E−01 |
| O | 6.015E−05 | −1.630E−01 | −1.630E−01 | 1.122E+00 | −1.017E−01 | −2.087E−02 |
| P | −1.826E−06 | 9.324E−03 | 9.324E−03 | −8.559E−02 | 5.980E−03 | 1.089E−03 |
| | S7 | S8 | S9 | S10 | S11 | S12 |
| K | −33.094 | 5.138 | 39.734 | −6.165 | 10.487 | −6.968 |
| A | −6.860E−02 | −5.844E−02 | 2.772E−02 | −5.284E−03 | −6.306E−02 | −3.282E−02 |
| B | −4.993E−02 | −5.807E−02 | −1.075E−01 | −7.464E−02 | 4.536E−02 | 1.121E−02 |
| C | 2.082E−01 | 1.541E−01 | 1.840E−01 | 1.290E−01 | −4.724E−02 | −6.793E−03 |
| D | −4.535E−01 | −2.278E−01 | −2.197E−01 | −1.282E−01 | 2.971E−02 | 3.093E−03 |
| E | 6.701E−01 | 2.304E−01 | 1.776E−01 | 8.174E−02 | −1.121E−02 | −8.919E−04 |
| F | −6.853E−01 | −1.616E−01 | −9.857E−02 | −3.519E−02 | 2.758E−03 | 1.708E−04 |
| G | 4.845E−01 | 7.798E−02 | 3.847E−02 | 1.062E−02 | −4.653E−04 | −2.272E−05 |
| H | −2.341E−01 | −2.513E−02 | −1.072E−02 | −2.297E−03 | 5.537E−05 | 2.147E−06 |
| J | 7.461E−02 | 4.945E−03 | 2.141E−03 | 3.586E−04 | −4.700E−06 | −1.452E−07 |
| L | −1.420E−02 | −3.980E−04 | −3.037E−04 | −4.012E−05 | 2.833E−07 | 6.976E−09 |
| M | 1.065E−03 | −5.715E−05 | 2.981E−05 | 3.139E−06 | −1.186E−08 | −2.327E−10 |
| N | 1.356E−04 | 1.898E−05 | −1.924E−06 | −1.630E−07 | 3.284E−10 | 5.124E−12 |
| O | −3.529E−05 | −2.004E−06 | 7.339E−08 | 5.050E−09 | −5.406E−12 | −6.712E−14 |
| P | 2.205E−06 | 7.911E−08 | −1.253E−09 | −7.057E−11 | 4.010E−14 | 3.970E−16 |

### Third Embodiment

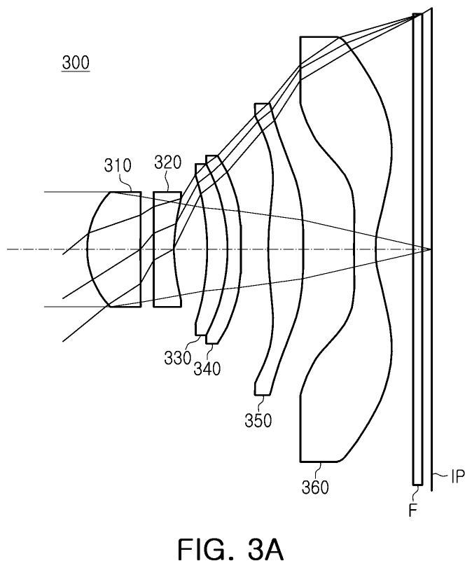

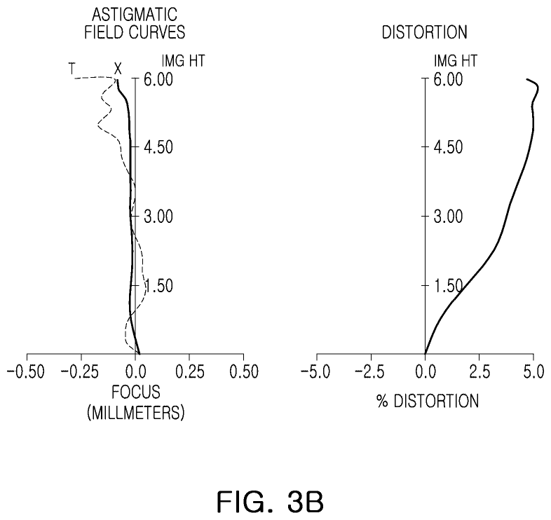

FIG. 3A is a configuration diagram illustrating an optical imaging system according to a third embodiment. FIG. 3B is a graph indicating aberration properties of the optical imaging system illustrated in FIG. 3A.

The optical imaging system 300 according to the third embodiment may include a first lens 310, a second lens 320, a third lens 330, a fourth lens 340, a fifth lens 350, and a sixth lens 360. A stop may be disposed on an object side of the first lens 310.

Also, the optical imaging system 300 may include a filter F and an imaging plane IP disposed on an image side of the sixth lens 360. The imaging plane IP may be a portion of an image sensor, in which light is received.

The total focal length of the optical imaging system 300 according to the third embodiment may be 6.70 mm, the IMG HT may be 6.00 mm, and the FOV may be 81.20 degrees (°).

The characteristics of each lens of the optical imaging system 300 according to the third embodiment may be as in Table 5 below.

TABLE 5

| Surface | | Radius of | Thickness/ | Refractive | Abbe | Focal |
|---|---|---|---|---|---|---|
| No. | Note | curvature | Distance | index | number | length |
| S1 | First | 3.021 | 1.232 | 1.565 | 62.04 | 5.99 |
| | lens | | | | | |
| S2 | | 23.359 | 0.275 | | | |
| S3 | Second | 62.439 | 0.558 | 1.690 | 20.64 | −14.40 |
| | lens | | | | | |
| S4 | | 8.622 | 0.753 | | | |
| S5 | Third | −17.863 | 0.478 | 1.553 | 57.42 | 12.44 |
| | lens | | | | | |
| S6 | | −5.029 | 0.000 | | | |
| S7 | Fourth | −5.029 | 0.329 | 1.697 | 30.52 | −11.90 |
| | lens | | | | | |
| S8 | | −12.987 | 0.672 | | | |
| S9 | Fifth | 19.678 | 0.831 | 1.567 | 37.40 | 6.80 |
| | lens | | | | | |
| S10 | | −4.762 | 1.235 | | | |
| S11 | Sixth | 12.766 | 0.520 | 1.535 | 55.74 | −5.22 |
| | lens | | | | | |
| S12 | | 2.265 | 0.843 | | | |
| S13 | Filter | Infinity | 0.237 | 1.517 | 64.17 | |
| S14 | | Infinity | 0.232 | | | |
| S15 | Imaging | Infinity | | | | |
| | plane | | | | | |

According to the third embodiment, the first lens 310 may have positive refractive power, the first surface (an object-side surface) of the first lens 310 may be convex in a paraxial region, and the second surface (an image-side surface) of the first lens 310 may be concave in a paraxial region.

The second lens 320 may have negative refractive power, the first surface (an object-side surface) of the second lens 320 may be convex in a paraxial region, and the second surface (an image-side surface) of the second lens 320 may be concave in a paraxial region.

The third lens 330 may have positive refractive power, the first surface (an object-side surface) of the third lens 330 may be concave in a paraxial region, and the second surface (an image-side surface) of the third lens 330 may be convex in a paraxial region.

The fourth lens 340 may have negative refractive power, the first surface (an object-side surface) of the fourth lens 340 may be concave in a paraxial region, and the second surface (an image-side surface) of the fourth lens 340 may be convex in a paraxial region.

The fifth lens 350 may have positive refractive power, and both the first surface (an object-side surface) of the fifth lens 350 and the second surface (an image-side surface) of the fifth lens 350 may be convex in paraxial regions.

The sixth lens 360 may have negative refractive power, the first surface (an object-side surface) of the sixth lens 360 may be convex in a paraxial region, and the second surface (an image-side surface) of the sixth lens 360 may be concave in a paraxial region.

According to the third embodiment, the third lens 330 and the fourth lens 340 may be configured as a cemented lens.

For example, the second surface (an image-side surface) of the third lens 330 and the first surface (an object-side surface) of the fourth lens 340 bonded to the second surface (an image-side surface) of the third lens 330 may be spherical surfaces.

According to the third embodiment, at least one surface of each of the first to sixth lenses 310-360 may be an aspherical surface.

Aspherical constants of each lens of the optical imaging system 300 according to the third embodiment may be as in Table 6 below.

TABLE 6

| | S1 | S2 | S3 | S4 | S5 | S6 |
|---|---|---|---|---|---|---|
| K | −0.445 | −96.825 | 55.634 | 21.105 | 34.867 | 0.000 |
| A | 7.973E−04 | 2.656E−03 | −1.065E−02 | 5.043E−03 | 8.266E−02 | 0.000E+00 |
| B | −2.400E−02 | −5.548E−02 | 2.927E−02 | 7.750E−03 | −4.873E−01 | 0.000E+00 |
| C | 1.962E−01 | 3.004E−01 | 4.121E−02 | −9.533E−02 | 1.549E+00 | 0.000E+00 |
| D | −7.495E−01 | −1.129E+00 | −5.359E−01 | 4.073E−01 | −3.248E+00 | 0.000E+00 |
| E | 1.694E+00 | 2.818E+00 | 1.772E+00 | −9.576E−01 | 4.656E+00 | 0.000E+00 |
| F | −2.461E+00 | −4.773E+00 | −3.376E+00 | 1.429E+00 | −4.700E+00 | 0.000E+00 |
| G | 2.370E+00 | 5.617E+00 | 4.245E+00 | −1.445E+00 | 3.412E+00 | 0.000E+00 |
| H | −1.510E+00 | −4.663E+00 | −3.704E+00 | 1.019E+00 | −1.798E+00 | 0.000E+00 |
| J | 6.058E−01 | 2.746E+00 | 2.284E+00 | −5.081E−01 | 6.885E−01 | 0.000E+00 |
| L | −1.246E−01 | −1.140E+00 | −9.936E−01 | 1.781E−01 | −1.894E−01 | 0.000E+00 |
| M | −4.441E−03 | 3.255E−01 | 2.985E−01 | −4.295E−02 | 3.641E−02 | 0.000E+00 |
| N | 9.309E−03 | −6.089E−02 | −5.891E−02 | 6.772E−03 | −4.644E−03 | 0.000E+00 |
| O | −2.107E−03 | 6.712E−03 | 6.875E−03 | −6.282E−04 | 3.527E−04 | 0.000E+00 |
| P | 1.663E−04 | −3.305E−04 | −3.593E−04 | 2.597E−05 | −1.206E−05 | 0.000E+00 |
| | S7 | S8 | S9 | S10 | S11 | S12 |
| K | 0.000 | 9.859 | −35.140 | −1.663 | −7.542 | −5.275 |
| A | 0.000E+00 | 2.353E−02 | 3.763E−02 | 4.588E−02 | −5.908E−02 | −2.953E−02 |
| B | 0.000E+00 | −7.583E−02 | −3.454E−02 | −3.690E−02 | 1.410E−02 | 5.994E−03 |
| C | 0.000E+00 | 9.964E−02 | 2.470E−02 | 2.953E−02 | −3.449E−03 | −3.004E−04 |
| D | 0.000E+00 | −8.444E−02 | −1.522E−02 | −1.831E−02 | 4.447E−04 | −3.085E−04 |
| E | 0.000E+00 | 3.806E−02 | 6.953E−03 | 7.831E−03 | 6.167E−05 | 1.194E−04 |
| F | 0.000E+00 | 5.818E−04 | −2.276E−03 | −2.328E−03 | −3.708E−05 | −2.342E−05 |
| G | 0.000E+00 | −1.236E−02 | 5.341E−04 | 4.907E−04 | 7.528E−06 | 2.954E−06 |
| H | 0.000E+00 | 8.460E−03 | −9.020E−05 | −7.414E−05 | −9.163E−07 | −2.562E−07 |
| J | 0.000E+00 | −3.190E−03 | 1.094E−05 | 8.036E−06 | 7.428E−08 | 1.564E−08 |
| L | 0.000E+00 | 7.719E−04 | −9.434E−07 | −6.187E−07 | −4.123E−09 | −6.720E−10 |
| M | 0.000E+00 | −1.228E−04 | 5.634E−08 | 3.299E−08 | 1.544E−10 | 1.990E−11 |
| N | 0.000E+00 | 1.248E−05 | −2.215E−09 | −1.157E−09 | −3.813E−12 | −3.868E−13 |
| O | 0.000E+00 | −7.362E−07 | 5.160E−11 | 2.401E−11 | 5.505E−14 | 4.439E−15 |
| P | 0.000E+00 | 1.919E−08 | −5.401E−13 | −2.232E−13 | −3.551E−16 | −2.279E−17 |

### Fourth Embodiment

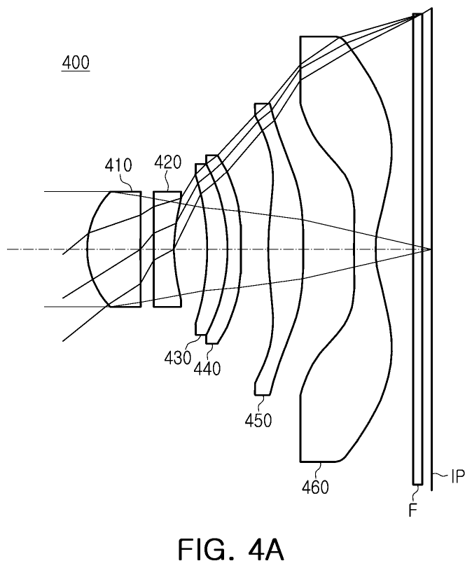

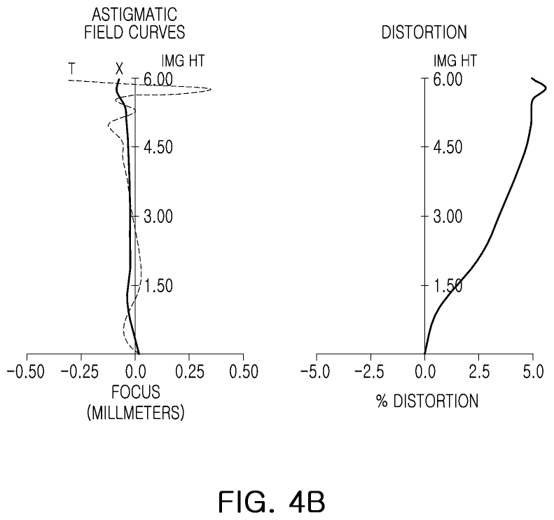

FIG. 4A is a configuration diagram illustrating an optical imaging system according to a fourth embodiment. FIG. 4B is a graph indicating aberration properties of the optical imaging system illustrated in FIG. 4A.

The optical imaging system 400 according to the fourth embodiment may include a first lens 410, a second lens 420, a third lens 430, a fourth lens 440, a fifth lens 450, and a sixth lens 460. A stop may be disposed on an object side of the first lens 410.

Also, the optical imaging system 400 may include a filter F and an imaging plane IP disposed on an image side of the sixth lens 460. The imaging plane IP may be a portion of an image sensor, in which light is received.

A total focal length of the optical imaging system 400 according to the fourth embodiment may be 6.71 mm, the IMG HT may be 6.00 mm, and the FOV may be 80.90 degrees (°).

The characteristics of each lens of the optical imaging system 400 according to the fourth embodiment may be as in Table 7 below.

TABLE 7

| Surface | | Radius of | Thickness/ | Refractive | Abbe | Focal |
|---|---|---|---|---|---|---|
| No. | Note | curvature | Distance | index | number | length |
| S1 | First | 3.021 | 1.242 | 1.570 | 62.09 | 5.98 |
| | lens | | | | | |
| S2 | | 22.082 | 0.273 | | | |
| S3 | Second | 53.789 | 0.564 | 1.690 | 22.40 | −14.75 |
| | lens | | | | | |
| S4 | | 8.598 | 0.754 | | | |
| S5 | Third | −18.052 | 0.500 | 1.566 | 61.58 | 11.63 |
| | lens | | | | | |
| S6 | | −4.886 | 0.000 | | | |
| S7 | Fourth | −4.886 | 0.334 | 1.697 | 30.13 | −11.29 |
| | lens | | | | | |
| S8 | | −13.081 | 0.695 | | | |
| S9 | Fifth | 20.003 | 0.856 | 1.567 | 37.40 | 6.92 |
| | lens | | | | | |
| S10 | | −4.845 | 1.235 | | | |
| S11 | Sixth | 12.791 | 0.507 | 1.535 | 55.74 | −5.00 |
| | lens | | | | | |
| S12 | | 2.190 | 0.843 | | | |
| S13 | Filter | Infinity | 0.237 | 1.517 | 64.17 | |
| S14 | | Infinity | 0.156 | | | |
| S15 | Imaging | Infinity | | | | |
| | plane | | | | | |

According to the fourth embodiment, the first lens 410 may have positive refractive power, the first surface (an object-side surface) of the first lens 410 may be convex in a paraxial region, and the second surface (an image-side surface) of the first lens 410 may be concave in a paraxial region.

The second lens 420 may have negative refractive power, the first surface (an object-side surface) of the second lens 420 may be convex in a paraxial region, and the second surface (an image-side surface) of the second lens 420 may be concave in a paraxial region.

The third lens 430 may have positive refractive power, the first surface (an object-side surface) of the third lens 430 may be concave in a paraxial region, and the second surface (an image-side surface) of the third lens 430 may be convex in a paraxial region.

The fourth lens 440 may have negative refractive power, the first surface (an object-side surface) of the fourth lens 440 may be concave in a paraxial region, and the second surface (an image-side surface) of the fourth lens 440 may be convex in a paraxial region.

The fifth lens 450 may have negative refractive power, and both the first surface (an object-side surface) of the fifth lens 450 and the second surface (an image-side surface) of the fifth lens 450 may be convex in a paraxial region.

The sixth lens 460 may have negative refractive power, the first surface (an object-side surface) of the sixth lens 460 may be convex in a paraxial region, and the second surface (an image-side surface) of the sixth lens 460 may be concave in a paraxial region.

According to the fourth embodiment, the third lens 430 and the fourth lens 440 may be configured as a cemented lens.

For example, the second surface (an image-side surface) of the third lens 430 and the first surface (an object-side surface) of the fourth lens 440 bonded to the second surface (an image-side surface) of the third lens 430 may be aspherical surfaces.

According to the fourth embodiment, at least one surface of each of the first to sixth lenses 410-460 may be an aspherical surface.

The aspherical constants of each lens of the optical imaging system 400 according to the fourth embodiment may be as in Table 8 below.

TABLE 8

| | S1 | S2 | S3 | S4 | S5 | S6 |
|---|---|---|---|---|---|---|
| K | −0.445 | −93.021 | 31.362 | 21.215 | 35.990 | 0.282 |
| A | 3.724E−03 | 1.562E−03 | −6.498E−03 | 6.891E−03 | 7.817E−02 | −3.690E−02 |
| B | −5.830E−02 | −4.737E−02 | 7.300E−04 | −9.629E−03 | −4.657E−01 | 2.712E−01 |
| C | 3.918E−01 | 2.329E−01 | 1.440E−01 | 2.512E−03 | 1.476E+00 | −8.839E−01 |
| D | −1.424E+00 | −7.726E−01 | −7.529E−01 | 6.667E−02 | −3.084E+00 | 1.674E+00 |
| E | 3.244E+00 | 1.698E+00 | 2.033E+00 | −1.849E−01 | 4.398E+00 | −2.059E+00 |
| F | −4.953E+00 | −2.545E+00 | −3.508E+00 | 2.343E−01 | −4.412E+00 | 1.744E+00 |
| G | 5.256E+00 | 2.658E+00 | 4.165E+00 | −1.459E−01 | 3.177E+00 | −1.053E+00 |
| H | −3.943E+00 | −1.954E+00 | −3.509E+00 | 1.259E−02 | −1.660E+00 | 4.617E−01 |
| J | 2.096E+00 | 1.010E+00 | 2.118E+00 | 5.049E−02 | 6.293E−01 | −1.477E−01 |
| L | −7.799E−01 | −3.614E−01 | −9.095E−01 | −4.172E−02 | −1.713E−01 | 3.425E−02 |
| M | 1.967E−01 | 8.643E−02 | 2.710E−01 | 1.691E−02 | 3.261E−02 | −5.611E−03 |
| N | −3.152E−02 | −1.289E−02 | −5.320E−02 | −3.935E−03 | −4.118E−03 | 6.167E−04 |
| O | 2.815E−03 | 1.038E−03 | 6.181E−03 | 5.032E−04 | 3.097E−04 | −4.082E−05 |
| P | −1.001E−04 | −3.106E−05 | −3.217E−04 | −2.753E−05 | −1.050E−05 | 1.230E−06 |
| | S7 | S8 | S9 | S10 | S11 | S12 |
| K | 0.282 | 9.417 | −35.866 | −1.670 | −7.576 | −5.249 |
| A | −3.690E−02 | 2.439E−02 | 3.751E−02 | 4.119E−02 | −5.942E−02 | −2.941E−02 |
| B | 2.712E−01 | −7.239E−02 | −3.378E−02 | −2.729E−02 | 1.424E−02 | 5.972E−03 |
| C | −8.839E−01 | 8.015E−02 | 2.328E−02 | 2.053E−02 | −3.496E−03 | −3.070E−04 |
| D | 1.674E+00 | −4.684E−02 | −1.391E−02 | −1.324E−02 | 4.547E−04 | −3.019E−04 |
| E | −2.059E+00 | −2.921E−03 | 6.214E−03 | 5.925E−03 | 6.144E−05 | 1.170E−04 |
| F | 1.744E+00 | 2.950E−02 | −1.995E−03 | −1.824E−03 | −3.750E−05 | −2.293E−05 |
| G | −1.053E+00 | −2.637E−02 | 4.595E−04 | 3.944E−04 | 7.647E−06 | 2.887E−06 |
| H | 4.617E−01 | 1.325E−02 | −7.597E−05 | −6.065E−05 | −9.337E−07 | −2.499E−07 |
| J | −1.477E−01 | −4.357E−03 | 8.985E−06 | 6.655E−06 | 7.590E−08 | 1.523E−08 |
| L | 3.425E−02 | 9.728E−04 | −7.502E−07 | −5.167E−07 | −4.223E−09 | −6.529E−10 |
| M | −5.611E−03 | −1.467E−04 | 4.301E−08 | 2.770E−08 | 1.596E−10 | 1.930E−11 |
| N | 6.167E−04 | 1.434E−05 | −1.605E−09 | −9.752E−10 | −3.925E−12 | −3.741E−13 |
| O | −4.082E−05 | −8.204E−07 | 3.496E−11 | 2.028E−11 | 5.678E−14 | 4.283E−15 |
| P | 1.230E−06 | 2.089E−08 | −3.352E−13 | −1.887E−13 | −3.671E−16 | −2.193E−17 |

### Fifth Embodiment

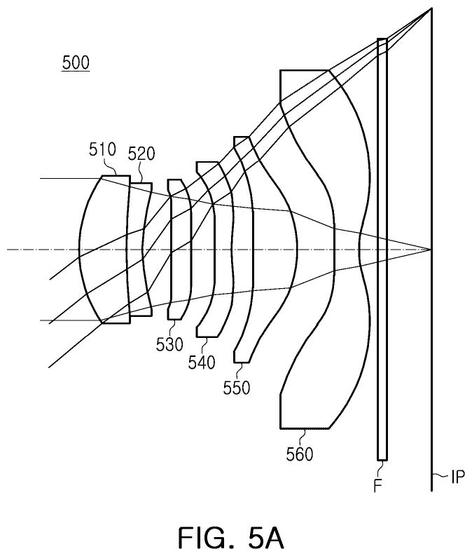

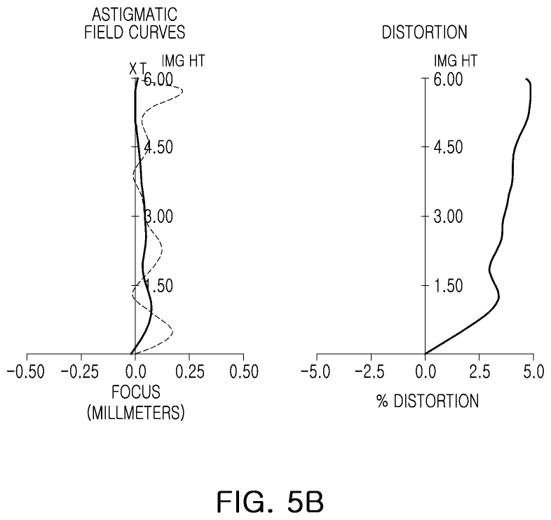

FIG. 5A is a configuration diagram illustrating an optical imaging system according to a fifth embodiment. FIG. 5B is a graph indicating aberration properties of the optical imaging system illustrated in FIG. 5A.

An optical imaging system 500 according to a fifth embodiment may include a first lens 510, a second lens 520, a third lens 530, a fourth lens 540, a fifth lens 550, and a sixth lens 560. A stop may be disposed between the second lens 520 and the third lens 530.

Also, the optical imaging system 500 may include a filter F and an imaging plane IP disposed on an image side of the sixth lens 560. The imaging plane IP may be a portion of an image sensor, in which light is received.

A total focal length of the optical imaging system 500 according to the fifth embodiment may be 6.94 mm, an IMG HT may be 6.00 mm, and an FOV may be 78.90 degrees) (°.

The characteristics of each lens of the optical imaging system 500 according to the fifth embodiment may be as in Table 9 below.

TABLE 9

| Surface | | Radius of | Thickness/ | Refractive | Abbe | Focal |
|---|---|---|---|---|---|---|
| No. | Note | curvature | Distance | index | number | length |
| S1 | First | 2.908 | 1.190 | 1.566 | 60.05 | 6.33 |
| | lens | | | | | |
| S2 | | 13.002 | 0.000 | | | |
| S3 | Second | 13.002 | 0.394 | 1.710 | 22.49 | −14.36 |
| | lens | | | | | |
| S4 | | 5.673 | 0.667 | | | |
| S5 | Third | 18.846 | 0.490 | 1.544 | 55.99 | 44.77 |
| | lens | | | | | |
| S6 | | 81.351 | 0.530 | | | |
| S7 | Fourth | 14.410 | 0.424 | 1.661 | 20.38 | −24.79 |
| | lens | | | | | |
| S8 | | 7.616 | 0.521 | | | |
| S9 | Fifth | −31.829 | 1.039 | 1.544 | 55.99 | 4.77 |
| | lens | | | | | |
| S10 | | −2.437 | 0.910 | | | |
| S11 | Sixth | −16.453 | 0.596 | 1.535 | 55.74 | −4.62 |
| | lens | | | | | |
| S12 | | 2.956 | 0.378 | | | |
| S13 | Filter | Infinity | 0.283 | 1.517 | 64.20 | |
| S14 | | Infinity | 1.079 | | | |
| S15 | Imaging | Infinity | | | | |
| | plane | | | | | |

According to the fifth embodiment, the first lens 510 may have positive refractive power, the first surface (an object-side surface) of the first lens 510 may be convex in a paraxial region, and the second surface (an image-side surface) of the first lens 510 may be concave in a paraxial region.

The second lens 520 may have negative refractive power, the first surface (an object-side surface) of the second lens 520 may be convex in a paraxial region, and the second surface (an image-side surface) of the second lens 520 may be concave in a paraxial region.

The third lens 530 may have positive refractive power, the first surface (an object-side surface) of the third lens 530 may be convex in a paraxial region, and the second surface (an image-side surface) of the third lens 530 may be concave in a paraxial region.

The fourth lens 540 may have negative refractive power, the first surface (an object-side surface) of the fourth lens 540 may be convex in a paraxial region, and the second surface (an image-side surface) of the fourth lens 540 may be concave in a paraxial region.

The fifth lens 550 may have positive refractive power, the first surface (an object-side surface) of the fifth lens 550 may be concave in a paraxial region, and the second surface (an image-side surface) of the fifth lens 550 may be convex in a paraxial region.

The sixth lens 560 may have negative refractive power, and both the first surface (an object-side surface) of the sixth lens 560 and the second surface (an image-side surface) of the sixth lens 560 may be concave in paraxial regions.

According to the fifth embodiment, the first lens 510 and the second lens 520 may be configured as a cemented lens.

For example, the second surface (an image-side surface) of the first lens 510 and the first surface (an object-side surface) of the second lens 520 bonded to the second surface (an image-side surface) of the first lens 510 may be spherical surfaces.

According to the fifth embodiment, at least one surface of each of the first to sixth lenses 510-560 may be an aspherical surface.

Aspherical constants of each lens of the optical imaging system 500 according to the fifth embodiment may be as in Table 10 below.

TABLE 10

| | S1 | S2 | S3 | S4 | S5 | S6 |
|---|---|---|---|---|---|---|
| K | 0.032 | 0.000 | 0.000 | −44.959 | −59.254 | −97.720 |
| A | −2.650E−03 | 0.000E+00 | 0.000E+00 | 2.337E−02 | −6.204E−02 | −6.451E−02 |
| B | 6.124E−03 | 0.000E+00 | 0.000E+00 | 6.029E−02 | 3.871E−01 | 2.519E−01 |
| C | 2.320E−03 | 0.000E+00 | 0.000E+00 | −3.376E−01 | −1.725E+00 | −8.657E−01 |
| D | −2.494E−02 | 0.000E+00 | 0.000E+00 | 9.229E−01 | 4.959E+00 | 1.973E+00 |
| E | 4.368E−02 | 0.000E+00 | 0.000E+00 | −1.519E+00 | −9.746E+00 | −3.106E+00 |
| F | −4.173E−02 | 0.000E+00 | 0.000E+00 | 1.479E+00 | 1.351E+01 | 3.467E+00 |
| G | 2.537E−02 | 0.000E+00 | 0.000E+00 | −6.309E−01 | −1.347E+01 | −2.794E+00 |
| H | −1.027E−02 | 0.000E+00 | 0.000E+00 | −3.315E−01 | 9.751E+00 | 1.641E+00 |
| J | 2.783E−03 | 0.000E+00 | 0.000E+00 | 6.991E−01 | −5.123E+00 | −7.016E−01 |
| L | −4.893E−04 | 0.000E+00 | 0.000E+00 | −5.126E−01 | 1.931E+00 | 2.160E−01 |
| M | 5.114E−05 | 0.000E+00 | 0.000E+00 | 2.172E−01 | −5.086E−01 | −4.658E−02 |
| N | −2.370E−06 | 0.000E+00 | 0.000E+00 | −5.587E−02 | 8.881E−02 | 6.674E−03 |
| O | −4.308E−08 | 0.000E+00 | 0.000E+00 | 8.128E−03 | −9.234E−03 | −5.703E−04 |
| P | 6.443E−09 | 0.000E+00 | 0.000E+00 | −5.151E−04 | 4.326E−04 | 2.197E−05 |
| | S7 | S8 | S9 | S10 | S11 | S12 |
| K | −32.765 | 5.078 | 11.552 | −6.188 | 10.822 | −6.567 |
| A | −4.071E−02 | −3.444E−02 | 2.128E−02 | 1.295E−02 | −6.259E−02 | −2.253E−02 |
| B | −6.977E−02 | −6.269E−02 | −6.672E−02 | −8.767E−02 | 4.830E−02 | 6.853E−04 |
| C | 2.676E−01 | 1.541E−01 | 9.640E−02 | 1.206E−01 | −3.361E−02 | 1.529E−03 |
| D | −5.448E−01 | −2.098E−01 | −9.252E−02 | −9.459E−02 | 1.455E−02 | −7.136E−04 |
| E | 7.021E−01 | 1.846E−01 | 5.814E−02 | 4.710E−02 | −3.996E−03 | 1.870E−04 |
| F | −6.079E−01 | −1.102E−01 | −2.463E−02 | −1.576E−02 | 7.360E−04 | −3.237E−05 |
| G | 3.658E−01 | 4.586E−02 | 7.254E−03 | 3.677E−03 | −9.442E−05 | 3.866E−06 |
| H | −1.558E−01 | −1.350E−02 | −1.515E−03 | −6.110E−04 | 8.618E−06 | −3.252E−07 |
| J | 4.717E−02 | 2.808E−03 | 2.260E−04 | 7.278E−05 | −5.637E−07 | 1.940E−08 |
| L | −1.007E−02 | −4.070E−04 | −2.389E−05 | −6.171E−06 | 2.626E−08 | −8.166E−10 |
| M | 1.479E−03 | 3.975E−05 | 1.747E−06 | 3.637E−07 | −8.511E−10 | 2.369E−11 |
| N | −1.419E−04 | −2.448E−06 | −8.404E−08 | −1.416E−08 | 1.824E−11 | −4.507E−13 |
| O | 7.995E−06 | 8.314E−08 | 2.392E−09 | 3.274E−10 | −2.325E−13 | 5.056E−15 |
| P | −2.001E−07 | −1.106E−09 | −3.050E−11 | −3.405E−12 | 1.334E−15 | −2.534E−17 |

### Sixth Embodiment

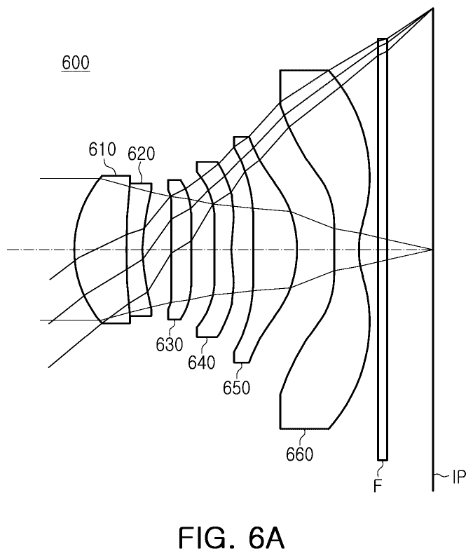

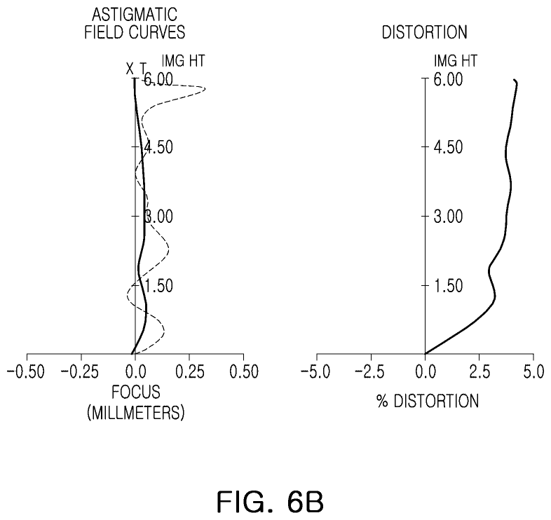

FIG. 6A is a configuration diagram illustrating an optical imaging system according to a sixth embodiment. FIG. 6B is a graph indicating aberration properties of the optical imaging system illustrated in FIG. 6A.

The optical imaging system 600 according to the sixth embodiment may include a first lens 610, a second lens 620, a third lens 630, a fourth lens 640, a fifth lens 650, and a sixth lens 660. A stop may be disposed between the second lens 620 and the third lens 630.

Also, the optical imaging system 600 may include a filter F and an imaging plane IP disposed on an image side of the sixth lens 660. The imaging plane IP may be a portion of an image sensor, in which light is received.

The optical imaging system 600 according to the sixth embodiment may have a total focal length of 6.97 mm, an IMG HT of 6.00 mm, and a FOV of 79.00 degrees) (°.

The characteristics of each lens of the optical imaging system 600 according to the sixth embodiment may be as in Table 11 below.

TABLE 11

| Surface | | Radius of | Thickness/ | Refractive | Abbe | Focal |
|---|---|---|---|---|---|---|
| No. | Note | curvature | Distance | index | number | length |
| S1 | First | 2.907 | 1.198 | 1.570 | 62.78 | 6.33 |
| | lens | | | | | |
| S2 | | 12.510 | 0.000 | | | |
| S3 | Second | 12.510 | 0.396 | 1.710 | 25.05 | −14.78 |
| | lens | | | | | |
| S4 | | 5.662 | 0.677 | | | |
| S5 | Third | 19.453 | 0.498 | 1.544 | 55.99 | 45.44 |
| | lens | | | | | |
| S6 | | 89.103 | 0.528 | | | |
| S7 | Fourth | 14.279 | 0.423 | 1.661 | 20.38 | −24.54 |
| | lens | | | | | |
| S8 | | 7.543 | 0.524 | | | |
| S9 | Fifth | −33.353 | 1.083 | 1.544 | 55.99 | 4.83 |
| | lens | | | | | |
| S10 | | −2.472 | 0.881 | | | |
| S11 | Sixth | −16.623 | 0.582 | 1.535 | 55.74 | −4.71 |
| | lens | | | | | |
| S12 | | 3.022 | 0.378 | | | |
| S13 | Filter | Infinity | 0.283 | 1.517 | 64.20 | |
| S14 | | Infinity | 1.078 | | | |
| S15 | Imaging | Infinity | | | | |
| | plane | | | | | |

According to the sixth embodiment, the first lens 610 may have positive refractive power, the first surface (an object-side surface) of the first lens 610 may be convex in a paraxial region, and the second surface (an image-side surface) of the first lens 610 may be concave in a paraxial region.

The second lens 620 may have negative refractive power, the first surface (an object-side surface) of the second lens 620 may be convex in a paraxial region, and the second surface (an image-side surface) of the second lens 620 may be concave in a paraxial region.

The third lens 630 may have positive refractive power, the first surface (an object-side surface) of the third lens 630 may be convex in a paraxial region, and the second surface (an image-side surface) of the third lens 630 may be concave in a paraxial region.

The fourth lens 640 may have negative refractive power, the first surface (an object-side surface) of the fourth lens 640 may be convex in a paraxial region, and the second surface (an image-side surface) of the fourth lens 640 may be concave in a paraxial region.

The fifth lens 650 may have positive refractive power, the first surface (an object-side surface) of the fifth lens 650 may be concave in a paraxial region, and the second surface (an image-side surface) of the fifth lens 650 may be convex in a paraxial region.

The sixth lens 660 may have negative refractive power, and both the first surface (an object-side surface) of the sixth lens 660 and the second surface (an image-side surface) of the sixth lens 660 may be concave in a paraxial region.

According to the sixth embodiment, the first lens 610 and the second lens 620 may be configured as a cemented lens.

For example, the second surface (an image-side surface) of the first lens 610 and the first surface (an object-side surface) of the second lens 620 bonded to the second surface (an image-side surface) of the first lens 610 may be aspherical surfaces.

According to the sixth embodiment, at least one surface of each of the first to sixth lenses 610-660 may be an aspherical surface.

Aspherical constants of each lens of the optical imaging system 600 according to the sixth embodiment may be as in Table 12 below.

TABLE 12

| | S1 | S2 | S3 | S4 | S5 | S6 |
|---|---|---|---|---|---|---|
| K | 0.029 | 1.216 | 1.216 | −44.489 | −61.814 | 81.874 |
| A | −2.654E−03 | −4.493E−03 | −4.493E−03 | 2.560E−02 | −5.799E−02 | −6.153E−02 |
| B | 1.393E−03 | 1.119E−01 | 1.119E−01 | 1.538E−02 | 3.280E−01 | 2.176E−01 |
| C | 2.522E−02 | −7.797E−01 | −7.797E−01 | 7.526E−03 | −1.380E+00 | −7.123E−01 |
| D | −7.955E−02 | 2.758E+00 | 2.758E+00 | −5.477E−01 | 3.758E+00 | 1.580E+00 |
| E | 1.226E−01 | −5.922E+00 | −5.922E+00 | 2.450E+00 | −6.984E+00 | −2.457E+00 |
| F | −1.164E−01 | 8.393E+00 | 8.393E+00 | −5.757E+00 | 9.138E+00 | 2.736E+00 |
| G | 7.377E−02 | −8.217E+00 | −8.217E+00 | 8.594E+00 | −8.587E+00 | −2.215E+00 |
| H | −3.220E−02 | 5.694E+00 | 5.694E+00 | −8.702E+00 | 5.858E+00 | 1.312E+00 |
| J | 9.791E−03 | −2.817E+00 | −2.817E+00 | 6.130E+00 | −2.903E+00 | −5.675E−01 |
| L | −2.060E−03 | 9.900E−01 | 9.900E−01 | −3.012E+00 | 1.034E+00 | 1.770E−01 |
| M | 2.925E−04 | −2.416E−01 | −2.416E−01 | 1.013E+00 | −2.581E−01 | −3.868E−02 |
| N | −2.657E−05 | 3.894E−02 | 3.894E−02 | −2.223E−01 | 4.286E−02 | 5.616E−03 |
| O | 1.383E−06 | −3.733E−03 | −3.733E−03 | 2.871E−02 | −4.254E−03 | −4.861E−04 |
| P | −3.096E−08 | 1.614E−04 | 1.614E−04 | −1.654E−03 | 1.912E−04 | 1.895E−05 |
| | S7 | S8 | S9 | S10 | S11 | S12 |
| K | −33.397 | 5.234 | 44.438 | −6.180 | 10.456 | −6.791 |
| A | −4.472E−02 | −3.422E−02 | 2.202E−02 | 6.726E−03 | −5.482E−02 | −1.287E−02 |
| B | −3.640E−02 | −5.672E−02 | −6.733E−02 | −7.207E−02 | 3.965E−02 | −7.732E−03 |
| C | 1.414E−01 | 1.308E−01 | 9.237E−02 | 9.894E−02 | −2.816E−02 | 5.597E−03 |
| D | −2.831E−01 | −1.709E−01 | −8.463E−02 | −7.650E−02 | 1.225E−02 | −1.964E−03 |
| E | 3.635E−01 | 1.478E−01 | 5.153E−02 | 3.746E−02 | −3.332E−03 | 4.452E−04 |
| F | −3.145E−01 | −8.817E−02 | −2.140E−02 | −1.233E−02 | 6.041E−04 | −6.952E−05 |
| G | 1.884E−01 | 3.711E−02 | 6.232E−03 | 2.835E−03 | −7.609E−05 | 7.681E−06 |
| H | −7.931E−02 | −1.114E−02 | −1.295E−03 | −4.654E−04 | 6.813E−06 | −6.083E−07 |
| J | 2.351E−02 | 2.382E−03 | 1.929E−04 | 5.492E−05 | −4.372E−07 | 3.462E−08 |
| L | −4.856E−03 | −3.579E−04 | −2.042E−05 | −4.625E−06 | 1.999E−08 | −1.403E−09 |
| M | 6.793E−04 | 3.664E−05 | 1.499E−06 | 2.714E−07 | −6.361E−10 | 3.946E−11 |
| N | −6.087E−05 | −2.407E−06 | −7.242E−08 | −1.054E−08 | 1.340E−11 | −7.312E−13 |
| O | 3.117E−06 | 9.020E−08 | 2.071E−09 | 2.435E−10 | −1.680E−13 | 8.024E−15 |
| P | −6.812E−08 | −1.429E−09 | −2.655E−11 | −2.534E−12 | 9.492E−16 | −3.946E−17 |

### Seventh Embodiment

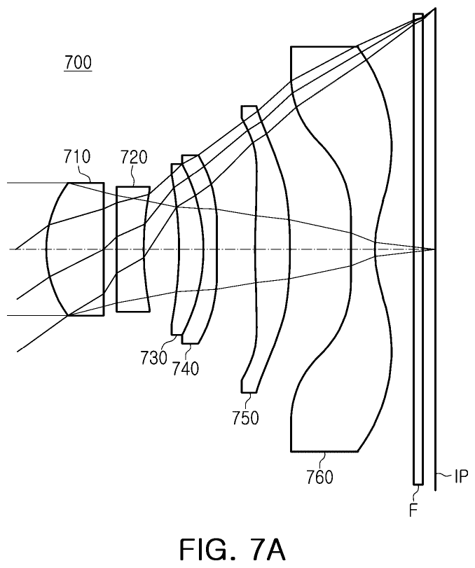

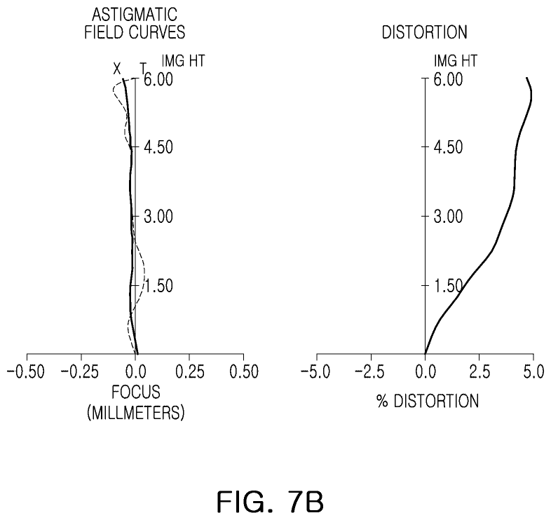

FIG. 7A is a configuration diagram illustrating an optical imaging system according to a seventh embodiment. FIG. 7B is a graph indicating aberration properties of the optical imaging system illustrated in FIG. 7A.

The optical imaging system 700 according to the seventh embodiment may include a first lens 710, a second lens 720, a third lens 730, a fourth lens 740, a fifth lens 750, and a sixth lens 760. A stop may be disposed on an object side of the first lens 710.

Also, the optical imaging system 700 may include a filter F and an imaging plane IP disposed on an image side of the sixth lens 760. The imaging plane IP may be a portion of an image sensor, in which light is received.

A total focal length of the optical imaging system 700 according to the seventh embodiment may be 7.59 mm, an IMG HT may be 6.00 mm, and a FOV may be 74.20 degrees (°).

The characteristics of each lens of the optical imaging system 700 according to the seventh embodiment may be as in Table 13 below.

TABLE 13

| Surface | | Radius of | Thickness/ | refractive | Abbe | focal |
|---|---|---|---|---|---|---|
| No. | Note | curvature | distance | index | number | length |
| S1 | First | 3.327 | 1.362 | 1.561 | 59.50 | 6.49 |
| | lens | | | | | |
| S2 | | 31.366 | 0.307 | | | |
| S3 | Second | 137.398 | 0.627 | 1.710 | 22.61 | −14.33 |
| | lens | | | | | |
| S4 | | 9.549 | 0.868 | | | |
| S5 | Third | −28.828 | 0.589 | 1.570 | 56.91 | 10.17 |
| | lens | | | | | |
| S6 | | −4.878 | 0.000 | | | |
| S7 | Fourth | −4.878 | 0.352 | 1.700 | 30.41 | −9.57 |
| | lens | | | | | |
| S8 | | −18.164 | 0.768 | | | |
| | Fifth | 20.603 | 0.963 | 1.567 | 37.40 | 7.56 |
| | lens | | | | | |
| S10 | | −5.364 | 1.389 | | | |
| S11 | Sixth | 12.620 | 0.580 | 1.535 | 55.74 | −5.87 |
| | lens | | | | | |
| S12 | | 2.482 | 0.935 | | | |
| S13 | Filter | Infinity | 0.260 | 1.517 | 64.17 | |
| S14 | | Infinity | 0.260 | | | |
| S15 | Imaging | Infinity | | | | |
| | plane | | | | | |

According to the seventh embodiment, the first lens 710 may have positive refractive power, the first surface (an object-side surface) of the first lens 710 may be convex in a paraxial region, and the second surface (an image-side surface) of the first lens 710 may be concave in a paraxial region.

The second lens 720 may have negative refractive power, the first surface (an object-side surface) of the second lens 720 may be convex in a paraxial region, and the second surface (an image-side surface) of the second lens 720 may be concave in a paraxial region.

The third lens 730 may have positive refractive power, the first surface (an object-side surface) of the third lens 730 may be concave in a paraxial region, and the second surface (an image-side surface) of the third lens 730 may be convex in a paraxial region.

The fourth lens 740 may have negative refractive power, the first surface (an object-side surface) of the fourth lens 740 may be concave in a paraxial region, and the second surface (an image-side surface) of the fourth lens 740 may be convex in a paraxial region.

The fifth lens 750 may have positive refractive power, and both the first surface (an object-side surface) of the fifth lens 750 and the second surface (an image-side surface) of the fifth lens 750 may be convex in a paraxial region.

The sixth lens 760 may have negative refractive power, the first surface (an object-side surface) of the sixth lens 760 may be convex in a paraxial region, and the second surface (an image-side surface) of the sixth lens 760 may be concave in a paraxial region.

According to the seventh embodiment, the third lens 730 and the fourth lens 740 may be configured as a cemented lens.

For example, the second surface (an image-side surface) of the third lens 730 and the first surface (an object-side surface) of the fourth lens 740 bonded to the second surface (an image-side surface) of the third lens 730 may be spherical surfaces.

According to the seventh embodiment, at least one surface of each of the first to sixth lenses 710-760 may be an aspherical surface.

Aspherical constants of each lens of the optical imaging system 700 according to the seventh embodiment may be as in Table 14 below.

TABLE 14

| | S1 | S2 | S3 | S4 | S5 | S6 |
|---|---|---|---|---|---|---|
| K | −0.432 | −97.427 | 98.879 | 20.994 | 35.334 | 0.000 |
| A | −4.290E−04 | −1.756E−03 | −9.148E−03 | 1.116E−02 | 5.957E−02 | 0.000E+00 |
| B | −2.386E−03 | −1.090E−02 | 4.430E−02 | −4.203E−02 | −2.865E−01 | 0.000E+00 |
| C | 4.926E−02 | 3.922E−02 | −1.446E−01 | 1.181E−01 | 7.382E−01 | 0.000E+00 |
| D | −2.201E−01 | −1.046E−01 | 3.118E−01 | −2.181E−01 | −1.263E+00 | 0.000E+00 |
| E | 5.276E−01 | 1.844E−01 | −4.542E−01 | 2.865E−01 | 1.482E+00 | 0.000E+00 |
| F | −7.932E−01 | −2.159E−01 | 4.492E−01 | −2.768E−01 | −1.227E+00 | 0.000E+00 |
| G | 7.978E−01 | 1.686E−01 | −2.978E−01 | 1.997E−01 | 7.309E−01 | 0.000E+00 |
| H | −5.536E−01 | −8.633E−02 | 1.253E−01 | −1.079E−01 | −3.161E−01 | 0.000E+00 |
| J | 2.678E−01 | 2.691E−02 | −2.713E−02 | 4.332E−02 | 9.926E−02 | 0.000E+00 |
| L | −8.973E−02 | −3.646E−03 | −1.411E−03 | −1.269E−02 | −2.238E−02 | 0.000E+00 |
| M | 2.027E−02 | −5.743E−04 | 2.743E−03 | 2.627E−03 | 3.527E−03 | 0.000E+00 |
| N | −2.914E−03 | 3.318E−04 | −7.869E−04 | −3.627E−04 | −3.686E−04 | 0.000E+00 |
| O | 2.365E−04 | −5.451E−05 | 1.044E−04 | 2.993E−05 | 2.293E−05 | 0.000E+00 |
| P | −7.972E−06 | 3.301E−06 | −5.578E−06 | −1.114E−06 | −6.423E−07 | 0.000E+00 |
| | S7 | S8 | S9 | S10 | S11 | S12 |
| K | 0.000 | 10.125 | −32.750 | −1.655 | −8.334 | −4.978 |
| A | 0.000E+00 | 1.995E−02 | 2.706E−02 | 3.223E−02 | −4.053E−02 | −1.797E−02 |
| B | 0.000E+00 | −5.476E−02 | −1.849E−02 | −2.031E−02 | 6.652E−03 | 5.477E−04 |
| C | 0.000E+00 | 6.571E−02 | 9.550E−03 | 1.336E−02 | −1.295E−03 | 1.164E−03 |
| D | 0.000E+00 | −5.446E−02 | −4.505E−03 | −6.938E−03 | 1.792E−04 | −4.959E−04 |
| E | 0.000E+00 | 3.001E−02 | 1.645E−03 | 2.476E−03 | 1.532E−06 | 1.120E−04 |
| F | 0.000E+00 | −1.038E−02 | −4.377E−04 | −6.113E−04 | −5.363E−06 | −1.627E−05 |
| G | 0.000E+00 | 1.820E−03 | 8.392E−05 | 1.066E−04 | 1.041E−06 | 1.620E−06 |
| H | 0.000E+00 | 1.150E−04 | −1.156E−05 | −1.329E−05 | −1.114E−07 | −1.137E−07 |
| J | 0.000E+00 | −1.554E−04 | 1.138E−06 | 1.187E−06 | 7.700E−09 | 5.681E−09 |
| L | 0.000E+00 | 4.298E−05 | −7.914E−08 | −7.525E−08 | −3.582E−10 | −2.011E−10 |
| M | 0.000E+00 | −6.585E−06 | 3.783E−09 | 3.301E−09 | 1.115E−11 | 4.932E−12 |
| N | 0.000E+00 | 6.048E−07 | −1.181E−10 | −9.523E−11 | −2.231E−13 | −7.967E−14 |
| O | 0.000E+00 | −3.127E−08 | 2.169E−12 | 1.625E−12 | 2.587E−15 | 7.626E−16 |
| P | 0.000E+00 | 7.028E−10 | −1.776E−14 | −1.242E−14 | −1.319E−17 | −3.277E−18 |

### Eighth Embodiment

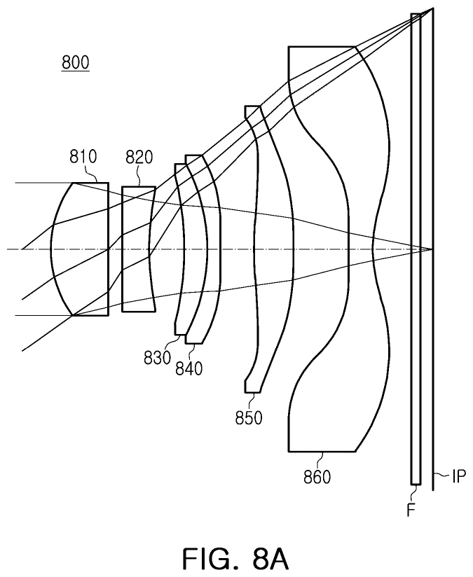

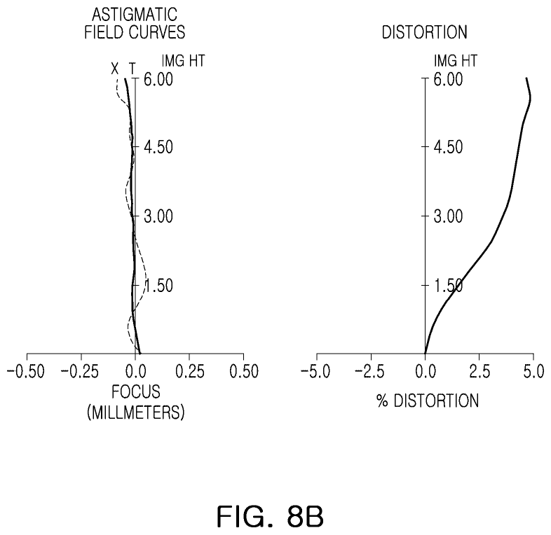

FIG. 8A is a configuration diagram illustrating an optical imaging system according to an eighth embodiment. FIG. 8B is a graph indicating aberration properties of the optical imaging system illustrated in FIG. 8A.

An optical imaging system 800 according to the eighth embodiment may include a first lens 810, a second lens 820, a third lens 830, a fourth lens 840, a fifth lens 850, and a sixth lens 860. A stop may be disposed on an object side of the first lens 810.

Also, the optical imaging system 800 may include a filter F and an imaging plane IP disposed on an image side of the sixth lens 860. The imaging plane IP may be a portion of an image sensor, in which light is received.

A total focal length of the optical imaging system 800 according to the eighth embodiment may be 7.48 mm, an IMG HT may be 6.00 mm, and an FOV may be 75.00 degrees (°).

The characteristics of each lens of the optical imaging system 800 according to the eighth embodiment may be as in Table 15 below.

TABLE 15

| Surface | | Radius of | Thickness/ | refractive | Abbe | focal |
|---|---|---|---|---|---|---|
| No. | Note | curvature | distance | index | number | length |
| S1 | First | 3.323 | 1.372 | 1.570 | 60.67 | 6.58 |
| | lens | | | | | |
| S2 | | 24.190 | 0.304 | | | |
| S3 | Second | 58.806 | 0.627 | 1.710 | 21.42 | −15.81 |
| | lens | | | | | |
| S4 | | 9.468 | 0.845 | | | |
| S5 | Third | −20.344 | 0.548 | 1.567 | 61.33 | 11.99 |
| | lens | | | | | |
| S6 | | −5.161 | 0.000 | | | |
| S7 | Fourth | −5.161 | 0.362 | 1.705 | 29.93 | −11.44 |
| | lens | | | | | |
| S8 | | −14.539 | 0.765 | | | |
| S9 | Fifth | 21.996 | 0.947 | 1.567 | 37.40 | 7.62 |
| | lens | | | | | |
| S10 | | −5.332 | 1.363 | | | |
| S11 | Sixth | 13.460 | 0.556 | 1.535 | 55.74 | −5.67 |
| | lens | | | | | |
| S12 | | 2.447 | 0.927 | | | |
| S13 | Filter | Infinity | 0.260 | 1.517 | 64.17 | |
| S14 | | Infinity | 0.227 | | | |
| S15 | Imaging | Infinity | | | | |
| | plane | | | | | |

According to the eighth embodiment, the first lens 810 may have positive refractive power, the first surface (an object-side surface) of the first lens 810 may be convex in a paraxial region, and the second surface (an image-side surface) of the first lens 810 may be concave in a paraxial region.

The second lens 820 may have negative refractive power, the first surface (an object-side surface) of the second lens 820 may be convex in a paraxial region, and the second surface (an image-side surface) of the second lens 820 may be concave in a paraxial region.

The third lens 830 may have positive refractive power, the first surface (an object-side surface) of the third lens 830 may be concave in a paraxial region, and the second surface (an image-side surface) of the third lens 830 may be convex in a paraxial region.

The fourth lens 840 may have negative refractive power, the first surface (an object-side surface) of the fourth lens 840 may be concave in a paraxial region, and the second surface (an image-side surface) of the fourth lens 840 may be convex in a paraxial region.

The fifth lens 850 may have positive refractive power, and both the first surface (an object-side surface) of the fifth lens 850 and the second surface (an image-side surface) of the fifth lens 850 may be convex in paraxial regions.

The sixth lens 860 may have negative refractive power, the first surface (an object-side surface) of the sixth lens 860 may be convex in a paraxial region, and the second surface (an image-side surface) of the sixth lens 860 may be concave in a paraxial region.

According to the eighth embodiment, the third lens 830 and the fourth lens 840 may be configured as a cemented lens.

For example, the second surface (an image-side surface) of the third lens 830 and the first surface (an object-side surface) of the fourth lens 840 bonded to the second surface (an image-side surface) of the third lens 830 may be aspherical surfaces.

According to the eighth embodiment, at least one surface of each of the first to sixth lenses 810-860 may be an aspherical surface.

Aspherical constants of each lens of the optical imaging system 800 according to the eighth embodiment may be as in Table 16 below.

TABLE 16

| | S1 | S2 | S3 | S4 | S5 | S6 |
|---|---|---|---|---|---|---|
| K | −0.442 | −94.938 | 53.269 | 21.176 | 35.449 | 0.417 |
| A | 3.934E−04 | 3.541E−03 | −9.516E−03 | 6.587E−03 | 5.989E−02 | −2.593E−02 |
| B | −1.175E−02 | −5.690E−02 | 5.062E−02 | −1.674E−02 | −2.953E−01 | 1.581E−01 |
| C | 9.892E−02 | 2.561E−01 | −1.632E−01 | 4.517E−02 | 7.723E−01 | −4.187E−01 |
| D | −3.779E−01 | −7.230E−01 | 3.244E−01 | −8.220E−02 | −1.329E+00 | 6.393E−01 |
| E | 8.569E−01 | 1.338E+00 | −4.143E−01 | 1.160E−01 | 1.562E+00 | −6.340E−01 |
| F | −1.268E+00 | −1.694E+00 | 3.359E−01 | −1.325E−01 | −1.293E+00 | 4.338E−01 |
| G | 1.283E+00 | 1.507E+00 | −1.537E−01 | 1.199E−01 | 7.684E−01 | −2.120E−01 |
| H | −9.114E−01 | −9.556E−01 | 1.245E−02 | −8.238E−02 | −3.316E−01 | 7.542E−02 |
| J | 4.581E−01 | 4.330E−01 | 3.198E−02 | 4.143E−02 | 1.040E−01 | −1.964E−02 |
| L | −1.620E−01 | −1.389E−01 | −2.256E−02 | −1.481E−02 | −2.342E−02 | 3.718E−03 |
| M | 3.938E−02 | 3.072E−02 | 7.863E−03 | 3.637E−03 | 3.689E−03 | −4.988E−04 |
| N | −6.249E−03 | −4.446E−03 | −1.591E−03 | −5.818E−04 | −3.856E−04 | 4.504E−05 |
| O | 5.817E−04 | 3.781E−04 | 1.783E−04 | 5.445E−05 | 2.402E−05 | −2.457E−06 |
| P | −2.400E−05 | −1.429E−05 | −8.605E−06 | −2.261E−06 | −6.742E−07 | 6.114E−08 |
| | S7 | S8 | S9 | S10 | S11 | S12 |
| K | 0.417 | 9.446 | −34.183 | −1.666 | −7.541 | −5.224 |
| A | −2.593E−02 | 1.708E−02 | 2.763E−02 | 3.132E−02 | −4.361E−02 | −2.147E−02 |
| B | 1.581E−01 | −4.014E−02 | −1.951E−02 | −1.741E−02 | 7.666E−03 | 2.768E−03 |
| C | −4.187E−01 | 3.322E−02 | 1.044E−02 | 1.060E−02 | −9.806E−04 | 4.340E−04 |
| D | 6.393E−01 | −1.313E−02 | −5.030E−03 | −5.482E−03 | −1.440E−04 | −3.346E−04 |
| E | −6.340E−01 | −3.844E−03 | 1.864E−03 | 1.983E−03 | 1.112E−04 | 8.606E−05 |
| F | 4.338E−01 | 8.625E−03 | −5.028E−04 | −4.973E−04 | −2.706E−05 | −1.318E−05 |
| G | −2.120E−01 | −5.757E−03 | 9.772E−05 | 8.801E−05 | 3.882E−06 | 1.348E−06 |
| H | 7.542E−02 | 2.299E−03 | −1.366E−05 | −1.12E−05 | −3.701E−07 | −9.612E−08 |
| J | −1.964E−02 | −6.125E−04 | 1.366E−06 | 1.004E−06 | 2.441E−08 | 4.852E−09 |
| L | 3.718E−03 | 1.119E−04 | −9.656E−08 | −6.428E−08 | −1.123E−09 | −1.729E−10 |
| M | −4.988E−04 | −1.388E−05 | 4.699E−09 | 2.843E−09 | 3.544E−11 | 4.257E−12 |
| N | 4.504E−05 | 1.120E−06 | −1.495E−10 | −8.260E−11 | −7.329E−13 | −6.888E−14 |
| O | −2.457E−06 | −5.301E−08 | 2.793E−12 | 1.418E−12 | 8.951E−15 | 6.592E−16 |
| P | 6.114E−08 | 1.118E−09 | −2.322E−14 | −1.090E−14 | −4.897E−17 | −2.826E−18 |

The conditional expression data according to embodiments is as in Table 17 below.

TABLE 17
Conditional expression

| Conditional | Embodiment | Embodiment | Embodiment | Embodiment |
|---|---|---|---|---|
| expression | 1 | 2 | 3 | 4 |
| \| fa/Va − | 0.721 | 0.712 | 0.607 | 0.564 |
| fb/Vb \| | | | | |
| f1/1 | 0.927 | 0.926 | 0.894 | 0.891 |
| f2/f | −2.240 | −2.223 | −2.149 | −2.198 |
| f3/f | 6.458 | 6.553 | 1.857 | 1.733 |
| f4/f | −3.560 | −3.586 | −1.776 | −1.683 |
| f5/f | 0.688 | 0.691 | 1.015 | 1.031 |
| f6/f | −0.677 | −0.687 | −0.779 | −0.745 |
| TTL/f | 1.217 | 1.221 | 1.223 | 1.221 |
| BFL/f | 0.262 | 0.260 | 0.196 | 0.184 |
| TTL/ | 0.622 | 0.622 | 0.683 | 0.683 |
| (2*IMG HT) | | | | |
| f/EPD | 1.969 | 1.893 | 2.269 | 2.271 |
| Conditional | Embodiment | Embodiment | Embodiment | Embodiment |
| expression | 5 | 6 | 7 | 8 |
| \| fa/Va − | 0.744 | 0.691 | 0.493 | 0.578 |
| fb/Vb \| | | | | |
| f1/f | 0.912 | 0.908 | 0.855 | 0.880 |
| f2/f | −2.069 | −2.121 | −1.888 | −2.114 |
| f3/f | 6.451 | 6.519 | 1.340 | 1.603 |
| f4/f | −3.572 | −3.521 | −1.261 | −1.529 |
| f5/f | 0.687 | 0.693 | 0.996 | 1.019 |
| f6/f | −0.666 | −0.676 | −0.773 | −0.758 |
| TTL/f | 1.225 | 1.224 | 1.220 | 1.217 |
| BFL/f | 0.251 | 0.249 | 0.192 | 0.189 |
| TTL/ | 0.708 | 0.711 | 0.772 | 0.759 |
| (2*IMG HT) | | | | |
| f/EPD | 1.969 | 1.892 | 2.290 | 2.270 |

According to the aforementioned embodiments, the optical imaging system may image a high-resolution image by reducing the total optical length and improving chromatic aberration.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens having positive refractive power, a second lens having negative refractive power, a third lens having positive refractive power, a fourth lens having negative refractive power, a fifth lens having positive refractive power, and a sixth lens having negative refractive power, disposed in order from an object side; and
a cemented lens,
wherein the cemented lens comprises the first lens and the second lens or the third lens and the fourth lens.

2. The optical imaging system of claim 1,
wherein the cemented lens comprises the first lens and the second lens, and
wherein an object-side surface of the second lens is convex in a paraxial region.

3. The optical imaging system of claim 1,
wherein the cemented lens comprises the third lens and the fourth lens, and
wherein an object-side surface of the fourth lens is concave in a paraxial region.

4. The optical imaging system of claim 1,
wherein the cemented lens satisfies the following conditional expression:
$$0 \leq \vert fa / Va - fb / Vb \vert < 2 ,$$
where fa and Va are a focal length and an Abbe number of a lens disposed on an object side among lenses cemented to each other, respectively, and fb and Vb are a focal length and an Abbe number of a lens disposed on an image side among the two lenses cemented to each other, respectively.

5. The optical imaging system of claim 1, wherein an object-side surface of the fifth lens is concave in a paraxial region.

6. The optical imaging system of claim 1, wherein an image-side surface of the second lens is concave in a paraxial region.

7. The optical imaging system of claim 1, wherein an image-side surface of the sixth lens is concave in a paraxial region.

8. The optical imaging system of claim 1, wherein the optical imaging system satisfies the following conditional expression:
$$1. < TTL / f < 1.3 ,$$
where TTL is a distance along an optical axis from an object-side surface of the first lens to an image plane, and f is a total focal length of the optical imaging system.

9. The optical imaging system of claim 1, wherein the first lens to the sixth lens are formed of plastic material.

10. An optical imaging system, comprising:
a first lens, a second lens, a third lens having positive refractive power, a fourth lens having negative refractive power and a convex object-side surface, a fifth lens having positive refractive power, and a sixth lens having negative refractive power, disposed in order from an object side,
wherein the optical imaging system satisfies the following conditional expression:
$$0.5 < TTL / ( 2 * IMG HT ) < 0.8 ,$$
where TTL is a distance along an optical axis from an object-side surface of the first lens to an image plane, and IMG HT is half a diagonal length of the image plane.

11. The optical imaging system of claim 10, wherein the optical imaging system satisfies the following conditional expression:
$$- 5 < f 4 / f < 0 ,$$
where f4 is a focal length of the fourth lens, and f is a total focal length of the optical imaging system.

12. The optical imaging system of claim 10, wherein the optical imaging system satisfies the following conditional expression:
$$- 2 < f 6 / f < 0 ,$$
where f6 is a focal length of the sixth lens, and f is a total focal length of the optical imaging system.

13. The optical imaging system of claim 10, wherein the optical imaging system satisfies the following conditional expression:
$$1 < f 3 / f < 8 ,$$
where f3 is a focal length of the third lens, and f is a total focal length of the optical imaging system.

14. The optical imaging system of claim 10, further comprising a cemented lens comprising the first lens and the second lens,
wherein an image-side surface of the third lens is concave in a paraxial region.

15. The optical imaging system of claim 10, further comprising a cemented lens comprising the third lens and the fourth lens,
wherein an image-side surface of the third lens is convex in a paraxial region.

16. The optical imaging system of claim 10, wherein an image-side surface of the second lens is concave in a paraxial region, and an image-side surface of the fifth lens is convex in a paraxial region.
